(19) United States
(12) Patent Application Publication
(10) Pub. No.: US 2013/0130799 A1
(43) Pub. Date: May 23, 2013

(54) BRAIN-COMPUTER INTERFACES AND USE THEREOF

(71) Applicants: Marc Van Hulle, Herent (BE); Nikolay V. Manyakov, Leuven (BE); Marijn Van Vliet, Heverlee (BE)

(72) Inventors: Marc Van Hulle, Herent (BE); Nikolay V. Manyakov, Leuven (BE); Marijn Van Vliet, Heverlee (BE)

(21) Appl. No.: 13/813,096

(22) PCT Filed: Jul. 19, 2011
(86) PCT No.: PCT/EP11/62307

§ 371 Date: Jan. 29, 2013

(30) Foreign Application Priority Data
Jul. 30, 2010 (GB) 1012787.6
Oct. 15, 2010 (GB) 1017463.9
Oct. 22, 2010 (GB) 1017866.3

(51) Int. Cl. G06F 3/01

(52) U.S. Cl. CPC G06F 3/01
USPC 463/36

(57) ABSTRACT

A computerized method for decoding visual evoked potentials involves obtaining a set of brain activity signals, the brain activity signals being recorded from a subject's brain during displaying a set of targets on a display having a display frame duration, at least one target being modulated periodically at a target-specific modulation parameter and decoding a visual evoked potential (VEP) from the brain activity signals. The decoding includes, at least for the at least one target being modulated at a target-specific modulation parameter, determining a representative time track from the obtained brain activity signals, the representative time track having a length being integer multiples of the display frame duration, analyzing at least one amplitude feature in the representative time track, and determining a most likely target of interest or absence thereof based on said analyzing.

### FIELD OF THE INVENTION

The present invention relates to the field of bioengineering and computer technology. More particularly, the present invention relates to methods and systems for decoding visual evoked potentials, as well as use of such methods and systems for providing a brain-computer interfacing. The visual evoked potentials thereby typically may be steady-state visual evoked potentials recorded while a subject is looking at stimuli displayed using certain modulation parameters.

### BACKGROUND OF THE INVENTION

Research on brain-computer interfaces (BCIs) has witnessed a tremendous development in recent years, and is now widely considered as one of the most successful applications of the neurosciences. Brain-Computer Interfacing (BCI) is a technology that aims to achieve control of a computer system by thought alone. This is achieved by measuring the user's brain activity and applying signal processing and machine learning techniques to interpret the recordings and act upon them. BCIs thereby thus are systems providing communication between subjects, typically living creatures on the one hand and machines such as computers on the other hand. BCIs can significantly improve the quality of life of patients suffering from amyotrophic lateral sclerosis, stroke, brain/spinal cord injury, cerebral palsy, muscular dystrophy, etc. Because this user group is rather limited, the field has recently turned towards applications for healthy users.

The technology as it exists today faces two mayor limitations when applied for day-to-day use: good recording equipment is expensive, bulky, uncomfortable and requires the help of a second person to apply (1) and when compared to traditional input devices, such as keyboards, mice and game controllers, BCI control is slow and inaccurate (2).

Multiple companies are working towards overcoming the first limitation, by developing better recording equipment that is cheap, comfortable and easy to apply. These recording setups all perform ElectroEncephalography (EEG), measuring differences in electric potential between an electrode placed on the scalp and a reference electrode (placed, for example, on an earlobe or on a mastoid). One of the main problems with the above headsets is the low signal-to-noise ratio. This means that only basic properties of the EEG signal can be measured.

This poor performance brings about the second limitation. Fast and accurate control requires a detailed decoding of the measured EEG signal, which becomes increasingly hard when the algorithms not only have to deal with interfering unrelated brain activity, but also sensor noise. This is the main reason why many commercial products today offer very limited BCI control to the user, working with concepts as relaxation/stress, meditation and detecting the user's mood, all of which boil down to analyzing different bands in the frequency spectrum of the recorded signal. Systems allowing the user more control, such as moving around a cursor and selecting objects on a screen, do exist but use clinical recording equipment. Modern clinical EEG equipment provides a superior signal to noise ratio, but has the downside of being not only expensive but also requiring the application of conductive gel and the help of a second person to place the electrodes on the scalp.

One of the primary markets for commercial applications of BCI technology is the video game industry. At the time of writing, there exist five BCI recording sets on the market that can be used at home. These sets are easy to use, portable and cheap, compared to clinical EEG equipment. Most of the available software for these sets is for (casual) gaming. These games are controlled by measuring the power of the user's brain activity in certain frequency bands (e.g. alpha, beta or mu power), which changes slowly, severely restricting the speed and accuracy of the control. Some games effectively can only give the illusion of control to the player.

The MindBall game developed by Interactive Productline lets two players compete against each other. The players sit on opposite sides of a table on which a ball is placed in the centre. It will roll to the player that is the least relaxed, who loses as soon as the ball reaches his/her side of the table. This scheme makes for an interesting game strategy, as the players try their best to be as relaxed as possible.

The recording equipment consists of a headband fitting electrodes, which is very easy to put on. The set limits itself to measuring alpha and theta band power.

The MindFlex system consists of an obstacle course through which a ball, hovering in the air by the use of a fan, can navigate. The power of the fan is controlled by the concentration of the player, providing vertical control of the ball. The direction of the fan is controlled by a turning knob on the side of the devices, providing horizontal control of the ball. This game is available in main street stores and is a very successful novelty item. However, it has received much critique, as the brain activity of the player has very limited influence, as demonstrated by taking off the headset and still being able to play the game by linking the electrodes together using a wet towel.

The recording equipment provided contains a headband with a single electrode placed on the forehead. Two reference electrodes are clipped to the earlobes. The developers of the recording equipment also provide the MindSet headset, discussed further on. Just like the MindBall game, the MindFlex recording set is limited to recording alpha and theta band power.

The Emotiv EPOC headset consists of 14 electrodes which require a bit of damping with a salt water solution. This makes the preparation a bit more of a hassle than the previously discussed MindBall and MindFlex games, but it is still far more convenient than what is required in a clinical setup.

As this headset is a general purpose EEG recording device, Emotiv encourages third parties to create software that works with the headset. Some games have been developed for the Emotiv set, including:

Emotipong, a simple pong game, where the player controls the paddle, Cerebral Constructor, a game of Tetris, where the player can move and rotate the falling blocks and
Jedi Mind Trainer (WingRaise), wherein the objective of this game is to concentrate. When the player is focused enough, a spacecraft will be raised.

This recording set comes with a software development kit (SDK) that provides access to the raw measurements, allowing in principle for the development of advanced control schemes. The player can control the system by imagining different types of movement, like thinking lifting/dropping an object or picturing a rotating cube. The game as well as the player undergo a training period in which machine learning is applied. The system also performs bandpower measurements that are linked to emotional states, such as excitement, tension, boredom, immersion, meditation and frustration. Information about the exact algorithms used is not available, but in all likelihood it uses alpha power desynchronization to detect these states.

The setup promises fairly sophisticated controls for players, providing Tetris and Pong games, which require quick and accurate responses. However, the mental command appear too hard to reliably decode from the EEG signal, as many reviews of the set point out that achieving control is very hard.

The NeuroSky MindSet headset can be worn as an ordinary set of headphones. A single electrode mounted on a movable arm is placed against the forehead and the earpieces contain reference electrodes that are placed on the mastoids. Several SDKs are available for free that allow developers to develop new applications for the set. Therefore, many games are already available.

Examples of games developed for the MindSet are Dagaz, a game that produces visualizations of the brain activity in the form of Mandala shapes whereby the game helps the player in meditation, Man.Up, wherein a keyboard is used to guide a figure through an obstacle course which scrolls upwards and whereby the game is over if the figure scrolls off the screen. Both the scrolling speed and the color palette are controlled by bandpower recordings. Another game is Invaders Reloaded which is a vertically scrolling 3D shoot-em-up. The concentration of the player controls the speed, power and upgrades of the weapons. There are many more games, but the main theme is that they all rely on measuring bandpower to control different aspects of the game.

The Enobio set, developed by Starlab, aims for academic and clinical EEG research and therefore has no commercial game options at the time of writing. The set consists of a headband with 4 slots in which dry electrodes can be placed. In addition, one DRL electrode, which requires gel, is fitted at the back of the head. As is the case with the Emotiv headset, developers have access to raw signal data from multiple electrodes which, in principle, can be used in control schemes.

Many games rely solely on measuring the power in one or more frequency bands of the EEG signal. The control scheme is such that most games would also be playable when the measured bandpower would be completely random. Such a scheme doesn't allow the player to directly control the game in term of commands like ‘up’, ‘down’, ‘push this button’, but rather enhance the game with a new task: to concentrate while playing.

The Emotive EPOC headset makes good promises regarding control schemes. Using mental tasks, the EPOC allows the player to give real time commands, controlling fast paced games. However, reviews indicate that the system does not always live up to its expectations.

The challenge is to come up with a control scheme that allows the player to issue fast and accurate commands that are robust enough to work even when the signal quality leaves much to be desired.

More complex brain computer interfaces are either invasive (intra-cranial) or noninvasive. The first ones have electrodes implanted mostly into the premotor- or motor frontal areas or into the parietal cortex, whereas the non-invasive ones mostly employ electroencephalograms (EEGs) recorded from the subject's scalp. The noninvasive methods can be further subdivided into three groups. The first group is based on the P300 (‘oddbal’) event-related potentials in the parietal cortex which is used to differentiate between an infrequent, but preferred stimulus, versus a frequent, but non-preferred stimuli in letter spelling systems. The second group of BCI's tries to detect imagined of right/left limb movements. This BCI uses slow cortical potentials (SCP), eventrelated desynchronization (ERD) of the mu- and betarhythm or the readiness potential. And the third group, which is also the subject of this study, uses the steady-state visual evoked potential (SSVEP). This type of BCI relies on the psychophysiological properties of EEG brain responses recorded from the occipital area during the periodic presentation of identical visual stimuli (flickering stimuli). When the periodic presentation is at a sufficiently high rate (>6 Hz), the individual transient visual responses overlap and become a steady state signal: the signal resonates at the stimulus rate and its multipliers (Luck, 2005).

This means that, when the subject is looking at stimuli flickering at the frequency f1, one can detect f1, 2 f1, 3 f1, . . . in the Fourier transform of the EEG signal recorded form the occipital pole. Traditional SSVEP detection techniques perform a FFT transform on the recorded data and apply which stimulus frequencies are strongly present in the signal. However, this technique requires the frequency of the stimulus to be extremely stable, something that is not easy to achieve with LCD screens and multitasking, general purpose computers which are not designed for precision timing. Since the spectral content of the EEG signal needs to be determined over a time window, the precision with which the stimulus frequency can be detected impedes the possibility to perform a rapid detection of the moment the subject looks away.

Since the amplitude of a typical EEG signal decreases as 1/f in the spectral domain, the higher harmonics become less prominent. Furthermore, the fundamental harmonic f1 is embedded into other on-going brain activity and (recording) noise. Thus, when considering a small recording interval it is quite likely to detect an (irrelevant) increase in the amplitude at frequency f1. To overcome this problem, averaging over several time intervals (Cheng et al., 2002), or recording over longer time intervals (Gao et al., 2006) are often used for increasing the signal-to-noise ratio in the spectral domain. Finally, in order to establish a means of direct communication from the brain to the computer, not one stimulus frequency f1, but several frequencies are used at the same time, f1, . . . , fn, each one corresponding to a particular command one wants to communicate. The detection problem, therefore, becomes more complex since now, one of several possible flickering frequencies fi need to be detected from the EEG recordings. For decoding the SSVEP BCI paradigm, traditionally, a representation in the spectral domain of the recorded EEG signal is used, hence, a variety of methods and classifiers have been described in the literature that rely on features based on amplitudes at particular frequencies (Cheng et al., 2002; Gao et al., 2006; de Peralta Menendez et al., 2009). In spite of the reported high transfer rates, achieving a reliable and fast classification still remains problematic. This can be due to the fact that, when using a computer screen for the stimuli, we don't have a precise refreshing rate of 60 Hz (in our case it is 59.83 Hz) (When using light-emmitting diodes (LEDs), one could precisely achieve 60 Hz, as was done in Luo and Sullivan, 2010). This can cause, for example, the oscillation, produced by two consecutive frames (intended to be at 30 Hz), not to exactly correspond to the desired one, which can deteriorate the decoding based on the Fourier transform (FT), when using short intervals.

Furthermore, when using too short intervals, neighboring frequencies can not be distinguished because of the limited spectral resolution. For example, 60/9=6.67 Hz and 60/8=7.5 Hz oscillations are indistinguishable after performing a fast FT based on a 500 ms interval (in other words, we have here a spectral resolution of 2 Hz). As was recently shown by Luo and co-workers (Luo and Sullivan, 2010), time domain classifiers yield a better performance than frequency based ones for the SSVEP paradigm.

### SUMMARY OF THE INVENTION

It is an object of embodiments of the present invention to provide good methods and systems for providing a brain computer interface.

It is an advantage of embodiments according to the present invention that a method is provided for selecting an item of interest based on visual evoked potentials, e.g. steady state visual evoked potentials.

It is an advantage of embodiments according to the present invention that a method for providing a brain-computer interface is obtained that is robust enough to work with portable recording equipment.

It is an advantage of embodiments according to the present invention that the methods and systems are suitable for video game applications.

The above objective is accomplished by a method and device according to the present invention.

The present invention relates to a computerized method for decoding visualevoked potentials, the method comprising obtaining a set of brain activity signals, the brain activity signals being recorded from a subsject's brain during displaying a set of targets on a display having a display frame duration, at least one target being modulated periodically at a target-specific modulation parameter, and decoding a visual evoked potential (VEP) from the brain activity signals, wherein said decoding comprises at least for the at least one target being modulated at a target-specific modulation parameter, determining a representative time track from the obtained brain activity signals, the representative time track having a length being integer multiples of the display frame duration, analyzing at least one amplitude feature in the representative time track, and determining a most likely target of interest or absence thereof based on said analyzing. The visual evoked potentials may be steady state visual evoked potentials. The modulation parameter may be a frequency, set of frequencies or a phase.

Determining a representative time track in the obtained brain activity signals for a target-specific modulation parameter may comprise deriving from the obtained brain activity signals a set comprising one or more subsequent time tracks, locked to the stimulus phase, and averaging the set of time tracks for obtaining the representative time track for the target-specific modulation parameter.

Determining a representative time track may comprise determining a representative time track having a length being inversely proportional with a frequency at which the target is displayed.

Determining a representative time track may comprise determining a representative time track having a length being substantially smaller than a time length required by a frequency analysis of the signal in order for the target to be distinguishable, with a comparable precision, from one or more other targets.

It is an advantage of embodiments according to the present invention that fast detection of a change in target of interest can be obtained, e.g. as only a small time track is required for detecting a change in the subject's gaze towards another target.

The brain activity signals may be encephalogram signals, captured at the subject's scalp during said displaying using one or more electrodes.

The brain activity signals may be captured using two or more electrodes. It is an advantage of embodiments according to the present invention that signals of more than one electrode can be used simultaneously, allowing to analyse more complex brain activity signals and/or allowing to obtain more accurate results.

The brain activity signals may be electro encephalogram (EEG) signals.

Analyzing at least one amplitude feature in the representative time track may include evaluating whether the representative time track shows a periodic waveform.

The set of targets may comprise a target being a VEP stimulus for the subject to keep gaze at and the set of targets furthermore may comprise sequentially displayed targets presenting options displayed in the periphery of the VEP stimulus at different presentation moments in time, wherein determining a representative time track may comprise frequently updating a representative time track of the target the subject currently gazes at during the period of said sequentially displaying targets presenting options and wherein analyzing one or more amplitude features in the representative time track may comprise detecting a moment at which a change in one or more amplitude features of the representative time track occurs, and wherein for determining a most likely target of interest, the method may comprise linking the moment at which a change in one or more amplitude features of the representative time track occur to the presentation moment for a target presenting an option and identifying that target as most likely target of interest.

It is an advantage of some embodiments of the present invention that these only rely on a single VEP stimulus, which can be detected in any user with sufficient visual capacities.

It is an advantage of embodiments of the present invention that there is no need for a multiple of stimuli that are flickering on the screen each at its own frequency. Displaying different stimuli each with their own frequency may be annoying and/or distracting. It is an advantage of some method embodiments according to the present invention that the methods do not suffer from the limited frequencies available as only one target needs to be displayed at a particular frequency. The limitations whereby the number of frequencies is limited because they are restricted to integer versions of the screen refresh rate, with a lower border set by the need to stay above 6 Hz, to obtain a steady state response, and the requirement to stay away from the alpha band (closing the eyes will lead to alpha rhythms which could be confounded with the target, when the latter would be flashing at a rate located in the alpha band) does not bring a limitation for these embodiments.

Furthermore, it is an advantage of these embodiments according to the present invention that these are not substantially influenced by the number of reliably detectable frequencies, which depends on the subject, and that these do not require a calibration phase to determine that number, as the latter would determine and limit the number of parallel selectable items. The absence of the need for a calibration phase may imply that no variable set-ups of the system used are required for different subjects.

Determining a most likely target of interest may be based on covert attention of the subject. It is an advantage of embodiments according to the present invention that a method and system is provided that allows users to make a selection between several options shown on a screen by using their ability to pay covert attention.

Detecting a moment at which a change in one or more amplitude features occurs may comprise analyzing if the value of one or more amplitude features crosses a predetermined threshold.

Each of the targets of the set of targets may be displayed modulated at a target-specific modulation parameter, and decoding a steady state visual evoked potential from the brain activity signals may comprise for one or more target-specific modulation parameter determining a representative time track, selecting a most likely representative time track or absence thereof based on one or more amplitude features in the representative time track for the one or more target-specific modulation parameter, and determining the most likely target of interest or absence thereof based on the most likely representative track or absence thereof.

Determining a representative time track may be performed for each target in the set of targets.

Selecting a most likely representative time track or absence thereof may be based on evaluating amplitude features in the representative time track for the one or more target-specific modulation parameter according to predetermined criteria.

Selecting a most likely representative time track or absence thereof may be based on comparison of amplitude features in the representative time track for the one or more target-specific modulation parameter with one or more amplitude features in stored time tracks for steady-state visual evoked potentials recorded for known targets of interest.

The obtained brain activity signals may be recorded on the occipital pole.

The method may comprise displaying a set of targets, at least one target being modulated at a target-specific modulation parameter.

The present invention also relates to a system for decoding visual evoked potentials, the system comprising an input means for obtaining a set of brain activity signals, the brain activity signals being recorded from the subject's brain during displaying of a set of targets, at least one target being modulated at a target-specific modulation parameter, a processing means for decoding a visual evoked potential (VEP) from the brain activity signals, the processing means comprising a representative time track determining means for determining, at least for the at least one target being modulated at a target-specific modulation parameter, a representative time track from the obtained brain activity signals, the representative time track having a length being integer multiples of frame duration, an analyzing means for analyzing at least one amplitude feature in the representative time track, and a target determination means for determining a most likely target of interest or absence thereof based on said analyzing.

The system furthermore may comprise a displaying means for displaying a set of targets, at least one target being modulated at a target-specific modulation parameter.

The present invention also relates to a controller programmed for controlling decoding of a visually evoked potential according to a method as described above.

The present invention furthermore relates to a computer program product for performing, when executed on a computer, a method as described above.

The present invention also relates to a machine readable data storage device storing the computer program product or to the transmission thereof over a local or wide area telecommunications network.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 illustrates a schematic flowchart of an exemplary method for decoding a visual evoked potential (VEP) according to an embodiment of the present invention.

FIG. 2 illustrates a schematic flowchart of an exemplary method for identification of a most likely target of interest based on covert attention, according to an embodiment of the present invention.

FIG. 3 illustrates a schematic flowchart of an exemplary method for identification of a most likely target of interest for targets displayed at a distinguishable frequency, according to an embodiment of the present invention.

FIG. 4 illustrates a principle of a method for detecting when a user looks away from the stimulus according to an embodiment of the present invention.

FIG. 5 illustrates a representation of a game world, which may benefit from embodiments according to the present invention.

FIG. 6 illustrates an example of an electrode placement on a subject's head, as can be used in embodiments according to the present invention.

FIG. 7 illustrates traces of EEG activity and their average, time locked to the stimuli onset, indicating features of embodiments according to the present invention.

FIG. 8 illustrates onset/offset detection accuracy as a function of the length of the EEG interval, illustrating features of embodiments according to the present invention.

FIG. 9 illustrates a spectrogram of EEG recordings, as can be used in embodiments of the present invention.

FIG. 10 illustrates individual representative time tracks of EEG activity at distinguishable frequencies and their averages time locked to the stimuli onset, illustrating features and advantages of embodiments according to the present invention.

FIG. 11 illustrates the decoding accuracy as function of the length of the EEG interval used for obtaining averaged time tracks in methods according to embodiments of the present invention.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Where in embodiments according to the present invention reference is made to covert attention, reference is made to the neural process of mentally focusing on a particular part of the sensory input.

Where in embodiments according to the present invention reference is made to visual evoked potentials (VEP), reference is made to signals that are natural responses to visual stimulation at specific frequencies. Steady State Visual Evoked Potentials (SSVEP) arise when the user is focussing on a stimulus, for instance a white circle on a black background, which flickers periodically, at a fixed frequency. Recordings at the occipital pole will show the presence of a synchronized waveform with the same frequency as the flickering stimulus. Higher order harmonics are often also present.

For example, when the retina is excited by a visual stimulus ranging from 3.5 Hz to 75 Hz, the brain generates electrical activity at the same or multiple of frequencies of the visual stimulus.

Where in embodiments according to the present invention reference is made to a target-specific modulation parameter, reference is made to a modulation parameter at which the target is modulated and which allows to detect the target, e.g. from the background signal, or in case of multiple targets, which allows to distinguish the different targets from each other. In such a case the modulation parameter can be identified as distinguishable modulation parameter. Where reference is made to a modulation parameter, reference may be made to a frequency or set of frequencies at which the displaying of the target is modulated or a phase at which the displaying of the target is modulated.

In the description provided herein, numerous specific details are set forth. However, it is understood that embodiments of the invention may be practiced without these specific details. In other instances, well-known methods, structures and techniques have not been shown in detail in order not to obscure an understanding of this description.

Embodiments of the present invention can be applied using different techniques for detecting brain activity, such as for example using electroencephalography (EEG) and magnetoencephalography (MEG), Electrocorticography (ECoG), functional magnetic resonance imaging (fMRI). The latter techniques provide information regarding activity, e.g. electrical activity, of a part of a living creature, such as for example of a brain of a human being.

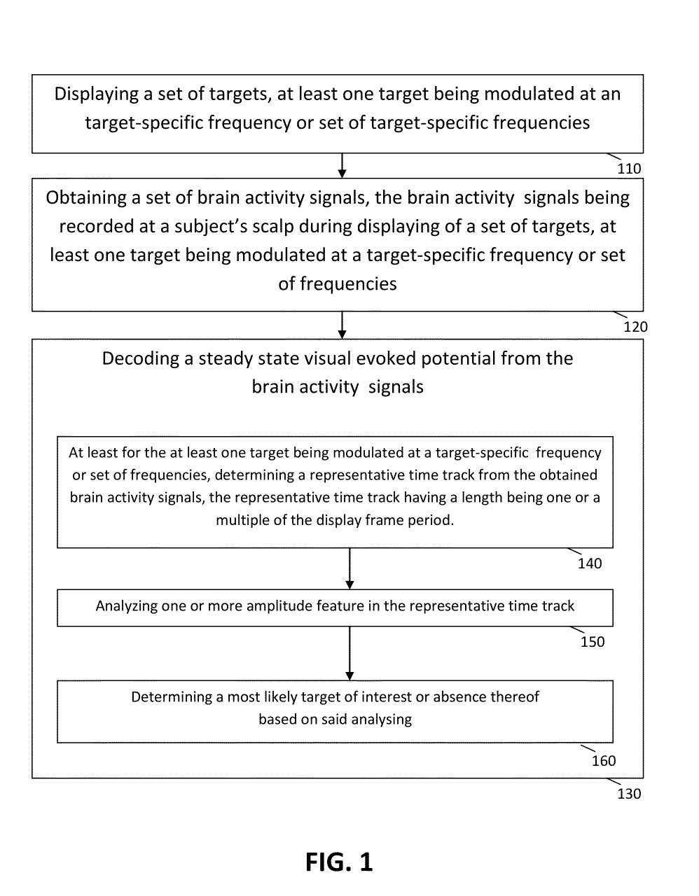

In a first aspect, the present invention relates to a method and system for decoding a visual evoked potential (VEP). The method is suitable for decoding brain activity signals, obtained using any method as described above. In advantageous embodiments, the method is based on encephalographic signals such as electric encenphalographic signals, embodiments of the present invention not being limited thereto. The computerized method comprises obtaining a set of brain activity signals being recorded from a subject's brain during displaying a set of targets on a display having a display frame duration. At least one target thereby is displayed in a periodically modulated manner using a modulation parameter, such as for example a frequency, set of frequencies or phase, being target-specific. Obtaining such a set of brain activity signals may comprise the act of displaying the targets on a display with a certain display frame duration and capturing the brain activity signals using a set of sensors postioned around the head of a living creature, e.g. using a set of electrodes positioned on the scalpel of the subject's brain. Alternatively, obtaining a set of brain activity signals may comprise receiving signal data as input, e.g. through an input port. The method also comprises decoding a visual evoked potential (VEP) from the brain activity signals. Whereas in the following embodiments and examples will be described with respect to steady state visual evoked potentials, aspects, embodiments and examples of the present invention are not limited thereto and other visual evoked potentials also can be used. In embodiments of the present invention, the decoding comprises at least for the at least one target being modulated at a target-specific modulation parameter, determining a representative time track from the obtained brain activity signals. The representative time track typically has a length being integer multiples of the display frame duration. The representative time track thereby may be obtained by deriving a set comprising one or more subsequent time tracks, locked to the stimulus phase, and averaging the set of time tracks for obtaining the representative time track for the target-specific modulation parameter. The number of time tracks used for averaging may depend on the required accuracy of the detection and the required speed of the detection, whereby typically a trade off needs to be made between accuracy and speed. The representative time track may have a length that is inversely proportional with the frequency at which the target is displayed. The length may be substantially smaller than a time length required by a frequency analysis of the signal in order for the target to be distinguishable, with a comparable precision, from one or more other targets. It is an advantage of embodiments according to the present invention that fast detection of a change in target of interest can be obtained, e.g. as only a small time track is required for detecting a change in the subject's gaze towards another target. Using a representative time track in the method as described according to embodiments of the present invention, is advantageous as the length of the time track used may be substantially shorter than the time track required for performing a frequency analysis. Decoding also comprises analyzing at least one amplitude feature in the representative time track, and determining a most likely target of interest or absence thereof based on the analysis. By way of illustration, different steps according to embodiments of the present invention are illustrated by the exemplary method 100 indicated in FIG. 1. Whereas in the following embodiments and examples, reference is made to a modulation parameter being a frequency or set of frequencies, embodiments of the present invention are not limited thereto. The modulation parameter may for example also be a phase. The steps of displaying the set of targets 110, obtaining the brain activity signals 12 and decoding a steady state visual evoked potential therefrom 130 are incidated. The decoding step 130 shown in FIG. 1 indicates a number of sub-steps, being determining 140 a representative time track for the at least one target being modulated, analyzing 150 one or more amplitude features in the representative time track and determining 160 a most likely target of interest or absence thereof based on the analyzing. Examples of amplitude features may be any suitable features, such as for example a signal amplitude crossing a predetermined level or sequence of possibly different levels, matching with templates obtained by averaging single tracks carrying the same label, wavelet feature detection, . . . . The amplitude feature may be a feature based on direct evaluation of the amplitude in the time track signal, without the need for correlating different features in the time track signal. As indicated, the SSVEP may be representative of a most likely target of interest, or, in absence of particular amplitude features may correspond with the absence of a most likely target. In particular embodiments, instead of one frequency, also a set of frequencies can be used, e.g. the target could be modulated with composite frequency contents, whereby the content has a specific amplitude feature signature. In some embodiments, the stimulation pattern of frequencies could be the same but a different phase may be used. In particular embodiments according to the present invention, the signals may be signals captured from more than one sensor, e.g. more than one electrode. Using signals of more than one electrode simultaneously can allow to analyse more complex brain activity signals and/or allowing to obtain more accurate results. The signals from the different electrodes may be pooled together.

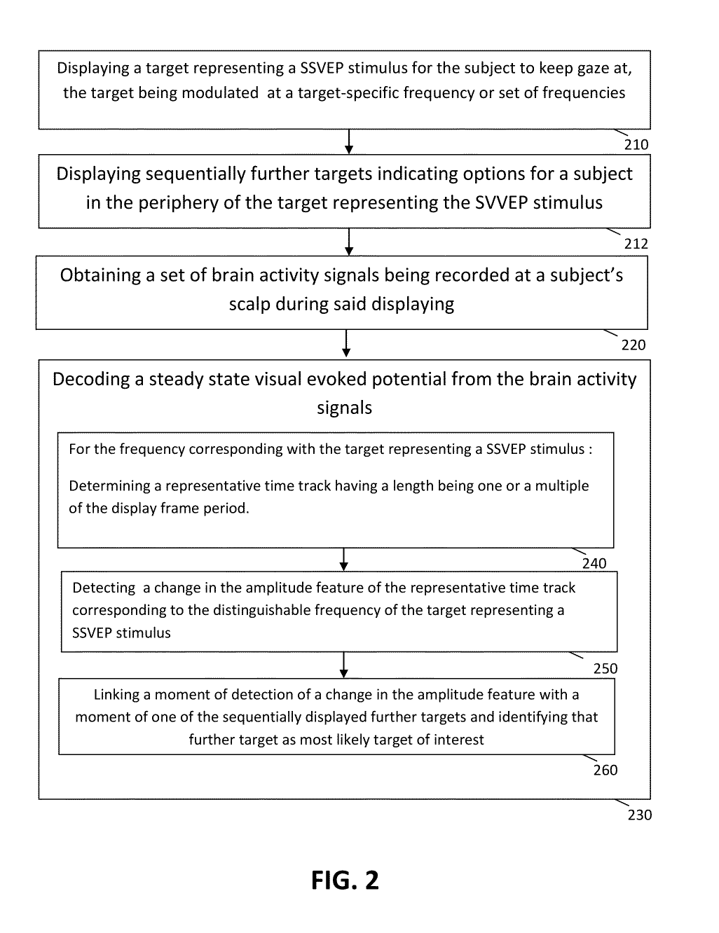

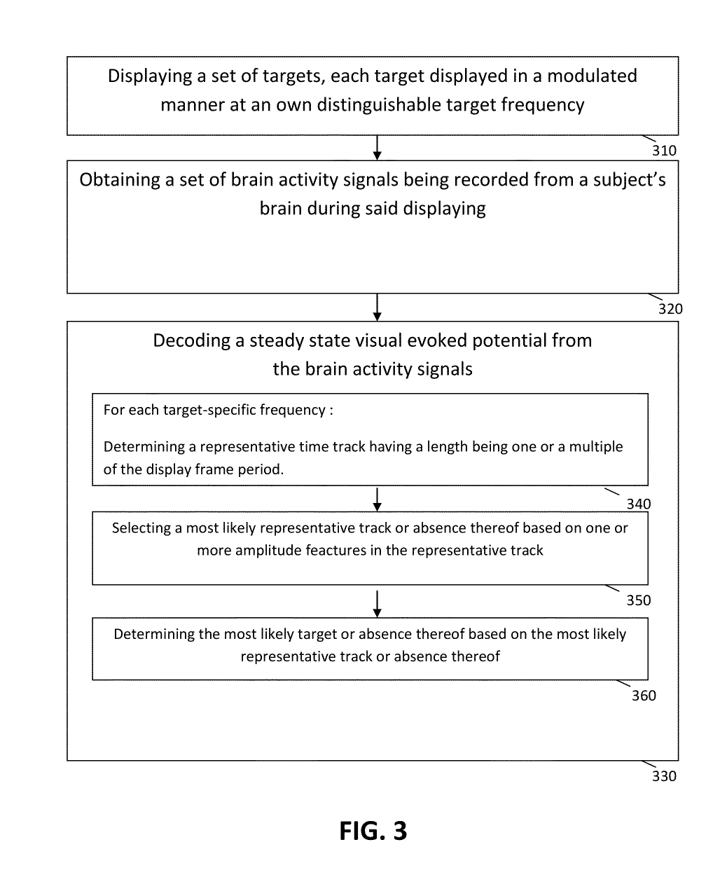

In one set of particular embodiments, use is made of covert attention. The user is focussing on the stimulus while options are highlighted sequentially in the periphery. As soon as the desired option is highlighted, the user looks away from the focussed stimulus. So options are selected by looking away from the focus. An exemplary method of such an embodiments is shown in FIG. 2. The method comprises obtaining a set of brain activity signals 220 obtained during displaying of the set of targets. In embodiments according to the present invention, typically the subject is request to keep gaze at a predetermined target representing a SSVEP stimulus. The target thereby Is displayed 210 in a modulated manner at a target specific frequency or set of frequencies. Further targets from the set are displayed 212 in the periphery of the predetermined target and are displayed in a sequentially manner. The subject thereby should keep the further targets covertly tracked but should keep its gaze at the central stimulus. The latter can be obtained through training. If the further target is a target of interest, the subject will remove its gaze of the predetermining target. The latter can be detected in the brain activity signals. Therefore, the method comprises decoding 230 a steady state visual evoked potential from the brain activity data by, for the predetermined target representing the SSVEP stimulus, determining 240 a representative time track, e.g. having the same features as described above, monitoring over time by frequently updating the representative time track one or more amplitude features in the time track. The representative time track may be obtained based on averaging in a moving window (for example as function of time the most recent. When the subject removes its gaze from the predetermined target towards a further target considered of interest, a change in the one or more amplitude features of the predetermined target will occur. The decoding therefore also comprises detecting 250 a change in one or more amplitude features of the representative time track at the target-specific frequency or set of frequencies of the predetermined target. As the further targets are displayed in a subsequent manner, linking 260 of the moment of the change in the representative time track at the target specific frequency or set of frequencies with the moment of displaying of the further targets, the target of interest can be identified by the system. The predetermined target may be displayed at a central position in the field of view of the subject, although embodiments of the present invention are not limited thereto, and it is sufficient to display the predetermined target a position such that the subject can keep its gaze on the predetermined target while allowing monitoring the further targets using covert attention. The further targets are displayed sequentially. The further targets may be displayed a single time, a plurality of times, periodically, . . . .

In a particular example of such embodiments, the user thus is presented with only one stimulus for example at or near the centre of a screen with a certain frequency, i.e. for example a single flashing stimulus. The frequency used can be a frequency known to be effective for SSVEP. While the user is focussing on the stimulus, options will be sequentially highlighted in the periphery. With some practice, the user can keep track of the highlighted options while still focussing on the SSVEP stimulus. As soon as the desired option is highlighted, the user looks away from the SSVEP stimulus. The decoding algorithm can detect the moment the user looks away, as the SSVEP waveform will suddenly disappear from the signal. Determining which option was selected is a simple matter of comparing the timing of the highlighted option with the timing of the user looking away from the SSVEP stimulus.

It is an advantage of embodiments of the present invention that a much faster interaction can be obtained, as detection when the user looks away can be performed even down to fractions of seconds. It is also an advantage that a technique is provided using amplitude variation in the SSVEP signal itself, contrary to frequency bands power detection methods. Using amplitude variation in the SSVEP signal itself leads to a much smaller chance of false detection and, therefore, a higher feeling of the user of being in control of the application, e.g. game. It is an advantage of embodiments of the present invention that use can be made of a single SSVEP frequency, rather than a separate (and different) frequency per selectable target, whereby use of a single SSVEP frequency is robust to define for a large group of players, and transparent for devices with different screen refresh rates, all leading to a system that will work out of the box. It also avoids the need for a calibration process. It is also an advantage of embodiments of the present invention that it is easy to instruct the subject where to focus, since this is the only item on the screen that is periodically flashing.

In another set of particular embodiments, the present invention also relates to a method of decoding a steady state visually evoked potential whereby a target of interest can be detected from a set of targets. In order to obtain this, a set of brain activity signals is being obtained 320 from a subject's brain during displaying 310 of a set of targets, each target displayed in a modulated manner at a target-specific frequency or set of frequencies. Each target thus has its own distinguishable frequency or set of frequencies. In this way a frequency or set of frequencies is characteristic for the target. The method also comprises decoding a steady state visual evoked potential 330 from the brain activity signals. In order to obtain such decoding a representative time track having a length being one or a multiple of the display frame period is determined 340. The representative time track may furthermore comprise one, more or all features and/or advantages as the representative time track described in aspects of embodiments of the present invention. For the target-specific frequency corresponding with the target of interest, i.e. the target to which the attention of the subject will be directed, the corresponding representative time track will comprise particular amplitude features. Such amplitude features may comprise one, more or all of the features and/or advantages of amplitude features in the representative time track as described above. The decoding method therefore comprises selecting a most likely representative track or absence thereof based on one or more amplitude features in the representative track 350. From the most likely representative track or absence thereof, the most likely target or absence thereof is determined. The latter may for example be performed by evaluating the one or more amplitude features with respect to predetermined criteria, using a predetermine algorithm or based on neural network processing. Evaluating amplitude features also may be performed by comparison of amplitude features in the representative time track for the one or more target-specific frequencies with one or more amplitude features in stored time tracks for steady-state visual evoked potentials recorded for known targets of interest.

In a particular example of such embodiments, a method comprising the following steps is described. In a first step, possible targets are periodically flashed or modulated during displaying on a display, using one frequency for each target that needs to be distinguished. Due to the display's fixed refresh rate, e.g., when the refresh rate is 60 Hz, we can use 30 Hz (every second a frame is intensified), 20, 15, 12, 10, 60/7, 7.5, 60/9, 6 Hz). EEG recordings then are made on the subject's scalp, on the occipital pole. From the EEG recordings, the SSVEP component is detected that can be assigned to the target, the subject's gaze is directed towards, and that can be distinguished from other targets shown on the display, and possibly also from the case when the subject is not looking at any target at all (hence, no target needs to be distinguished) using an amplitude feature. The SSVEP is detected by taking subsequent tracks of recorded EEG data from one electrode, or several electrodes, of length approximately equal to integer multiples of the frame duration (thus, the inverse of the display's refresh rate), with small track lengths for the higher frequency targets and larger track lengths for the smaller frequency targets, and with the subsequent tracks averaged with respect to the target phase or onset. The averaged track, corresponding to the target frequency the subject's gaze is directed towards, shows a characteristic, periodic waveform, as well as those tracks representing the integer divisions of the target frequency. The averaged tracks are then applied to a bank of signal amplitude features, that priorly have been properly selected, using a feature selection procedure, and the resulting features scores applied to a classifier that indicates the most likely target the subject's gaze is directed towards, or in the absence of a clear indication, from which it can be inferred that the subject is most likely not looking at any target at all.

It is an advantage of these embodiments of the present invention that discrimination of targets in the time domain is performed, allowing to overcome the problem that some frequencies are not distinguishable in the power spectral density domain, while still use can be made of a display, e.g. display screen or projection screen, for displaying the targets and by taking into account the display frame period. In other words, it is an advantage of embodiments of the present invention that the several targets can be jointly shown on a display having a limited refreshing rate. It is an advantage of embodiments according to the present invention that amplitude features can be used allowing accurate detection. It is an advantage of these embodiments that a feature selection procedure can be applied, for selecting the proper features, and that a powerful classifier (LDA, SVM, . . . ) can be applied to directly select the proper set of amplitude features. It is an advantage of embodiments according to the present invention that methods are provided that do not require the setting of such a threshold parameter but wherein the target can be decided based on directly comparing posterior target probabilities. It is an advantage of embodiments according to the present invention that the feature selection and classification approach to amplitude-based VEP decoding according to embodiments of the present invention extends to the case of multiple electrodes. It is an advantage of these embodiments that the approach is also applicable to targets stimulated with more complex, but repetitive waveforms than sinusoids, such as with asymmetric waveforms e.g. a smaller positive going wave followed by a larger negative one, or with composite waveforms, such as in the case of the pseudorandom code modulated visual evoked potentials VEP's.

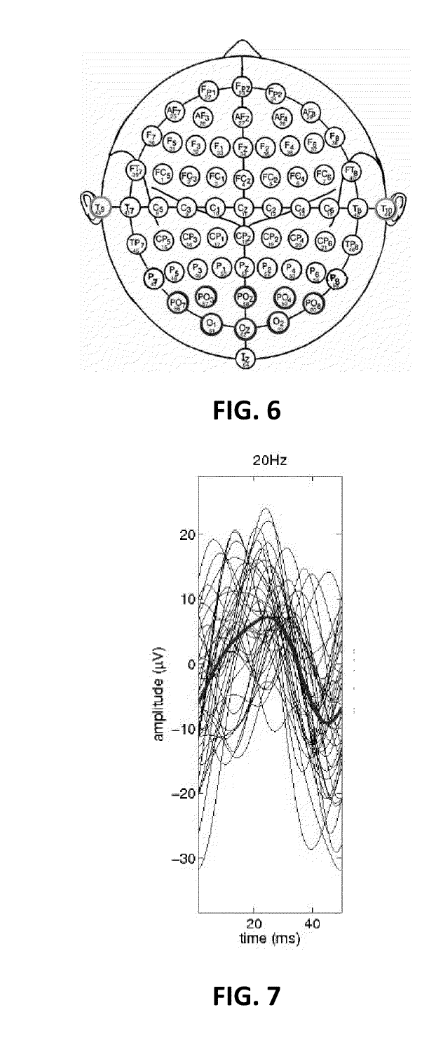

In one aspect, the present invention also relates to a system for decoding a visual evoked potential. The system according to embodiments of the present invention comprise an input means for obtaining a set of brain activity signals. The input thereby is such that the brain activity signals are recorded from the subject's brain during displaying of a set of targets, whereby at least one of the targets is modulated at a target-specific modulation parameter, such as for example a frequency, set of frequencies or phase. The input means may be adapted for receiving the signals as data input from an external source. In other words, the input means may be a data receiving input port. The input means alternatively may comprise a system for measuring brain activity signals. Such systems may for example be an electric encephalogram system, a magnetic encephalogram system, a functional magnetic resonance imaging system, an electrocorticography system, etc. typically comprising a set of sensors for sensing brain activity signals. By way of illustration, embodiments of the present invention not being limited thereto, an example of a set of sensors, in the present example being electrodes, connected and configured for measuring signals on the scalpel of the subject, e.g. living creature, is shown in FIG. 6. The system furthermore may comprise a displaying system having a display with a display frame period for displaying frames. The display system thereby may be configured for presenting a set of targets to the subject, during measurement of the brain activity signals. At least one target, and depending on the application optionally all targets of the set, may be displayed at a target-specific modulation parameter. The system furthermore may comprise a processing means or processor for decoding a visual evoked potential (VEP). The processor thereby may be configured for performing a decoding process as described in any of the above embodiments. The processing means therefore may comprise a representative time track determining means for determining, at least for the at least one target being modulated at a target-specific modulation parameter, a representative time track from the obtained brain activity signals, the representative time track having a length being integer multiples of frame duration. The processing means also may comprise an analyzing means for analyzing at least one amplitude feature in the representative time track and a target determination means for determining a most likely target of interest or absence thereof based on said analyzing. The different components may be controlled by a controller programmed for controlling the system components such that a method for decoding a steady state visual evoked potential as described above is performed. In one aspect the present invention therefore also relates to such a controller as such.

The system or components thereof furthermore may comprise additional components adapted or configured for performing any of the method features as described above for methods according to embodiments of the present invention. The system may be implemented as computing device. Such a computing device may comprise a hardware implemented processor or may be a software implemented processor, the software being implemented on a general purpose processor. The computing device may comprise standard and optional components as well known in the art such as for example a programmable processor coupled to a memory subsystem including at least one form of memory, e.g., RAM, ROM, and so forth. The computing device also may include a storage subsystem, a display system, a keyboard and/or a pointing device for allowing input information. Ports for inputting and outputting data also may be included. More elements such as network connections, interfaces to various devices, and so forth, may be included. The various elements of the processing system may be coupled in various ways, including via a bus subsystem. The memory of the memory subsystem may at some time hold part or all of a set of instructions that when executed on the processing system implement the steps of the method embodiments described herein.

In a further aspect, the present invention relates to a computer program product for, when executing on a processing means, carrying out one of the methods for decoding a visual evoked potential according to an embodiment of the present invention. The corresponding processing system may be a computing device as described above. In other words, methods according to embodiments of the present invention may be implemented as computer-implemented methods, e.g. implemented in a software based manner. Thus, one or more aspects of embodiments of the present invention can be implemented in digital electronic circuitry, or in computer hardware, firmware, software, or in combinations of them.

In further aspects, the present invention relates to a data carrier for storing a computer program product for implementing a method as described above or to the transmission thereof over a wide or local area network. Such a data carrier can thus tangibly embody a computer program product implementing a method as described above. The carrier medium therefore may carry machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

By way of illustration, embodiments of the present invention not being limited thereby, particular examples will be discussed, illustrating standard and optional features and advantages of embodiments according to the present invention.

In a first example, application in videogames is discussed, based on a method for decoding a steady state visual evoked potential using covert attention. The example game is an adaptation of a well-known casual gaming genre called Tower Defence. As the name implies, the objective of the game is to defend your tower. Enemies will come to attack the tower and do so by arriving in waves. As the game progresses, the waves of enemies become increasingly strong. To defend the tower, the player constructs defensive structures on strategic places on the map. These structures function autonomously: only the type and placement is controlled by the player.

FIG. 5 presents the game world, which consists of five elements: Gateways where waves of enemies arrive (1), paths on which the enemies walk (2), to player's tower which the enemies try to reach (3), building sites on which defensive structures can be build (4), defensive structures that will autonomously kill enemies (5). There are two types of enemies: Weak enemies with only a few hit points which typically arrive in vast hordes and strong enemies with lots of HP (hit points) which typically arrive in small packs. There are three types of structures: A cannon that shoots at enemies, which will take down weak enemies in one shot and strong enemies in multiple shots, a coil which does continuous damage to the enemies and which will take down weak enemies quickly and strong enemies slowly and a tower which fires bursts of energy and takes time to recharge, thus has a low firing rate, but does massive damage as it takes out all enemies in one shot. With each enemy killed, the player will be rewarded with some money, whereby the money can be spend to build new structures, move existing structures, change the type of an existing structure or upgrade the damage, rate of fire or turning speed of an existing structure. The game will consist of multiple turns. Each turn is structured as follows: (I) The player is informed on the number and type of enemies waiting at each gate. (II) The player selects a building site, ‘undo’ to undo the last command or ‘done’ to skip ahead to (IV). In step (II) the player may have selected an empty site and selects type of structure, which will in turn be build on the site. In step (II), the player may have selected an occupied site whereby the player chooses whether to upgrade, move or change the type of structure. Move thereby means that the player selects a vacant site to move the structure to or an occupied site to swap the two structures. Upgrade thereby means that the player selects the type of upgrade (damage, firing rate, turning speed). Change type thereby means that the player selects a new type of structure (shoot, burst, continuous). Step (III) may be indicative of a loop, and indicates repeating step (II). Step (IV) indicates the end of the turn whereby the gates open and enemies are released. The player will have no control until all enemies have been defeated or an enemy reaches the tower. The game has multiple maps/levels, each one increasing in difficulty and requiring different tactics to win. The player wins when all the waves of enemies have been defeated. The player loses when an enemy reaches the main tower.

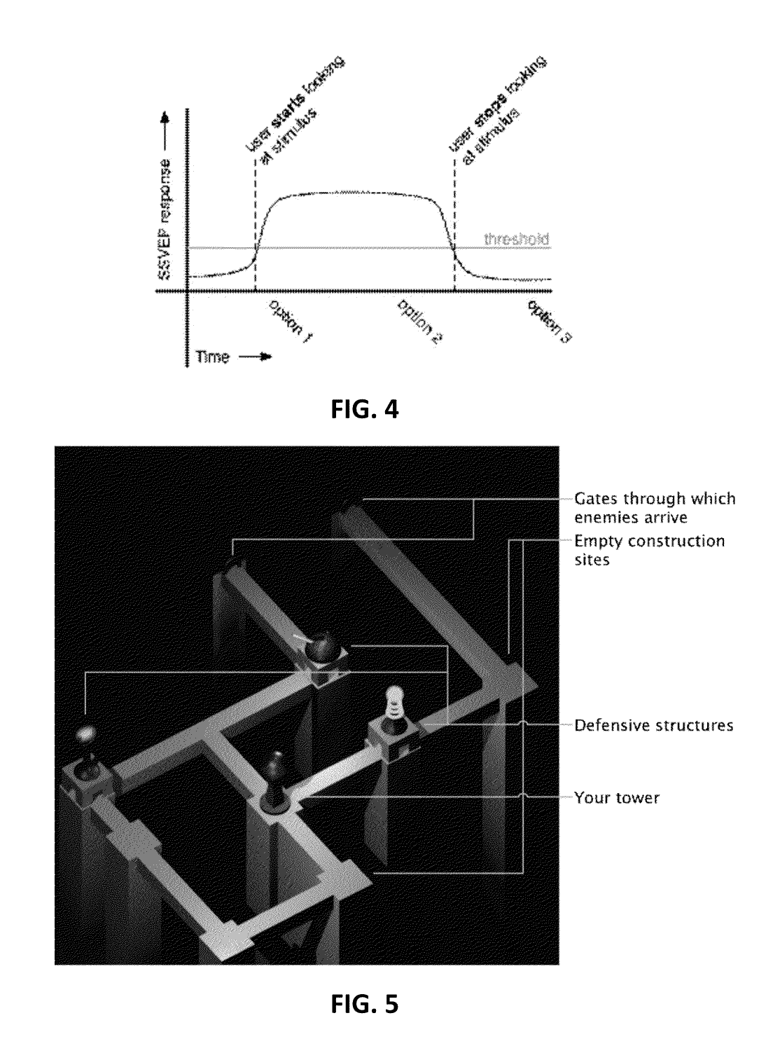

The player needs to select a type of structure and the construction site to build it on. These types of selections are perfectly suited for the SSVEP control scheme. The user is informed to direct and keep his/her gaze focussed on a stimulus at or near the centre of the screen that is flashing repeatedly at a certain frequency. The flashing stimulus is detected in the EEG signal recorded simultaneously at the occipital pole of the user (i.e., a SSVEP stimulation paradigm). While the user is performing this task, options will be highlighted, one after the other, in the periphery of the flashing stimulus. With some practice, the user can mentally keep track of which option is highlighted while still focussing on the SSVEP stimulus (covert attention). As soon as the desired option is highlighted, the user looks away from the SSVEP stimulus. The decoding algorithm can detect the moment the user looks away, as the SSVEP waveform will suddenly disappear from the signal, as illustrated in FIG. 4. FIG. 4 illustrates the scenario for selection by detecting when the user looks away from the stimulus and comparing it to the timing of the highlighting of the selection options where in the illustrated scenario the user has selected option 2. Determining which option was selected is a simple matter of comparing the timing of the option highlighted with the timing of the user looking away from the SSVEP stimulus. In this example, the main tower will host a large sphere, which will act as SSVEP stimulus. Whenever a selection needs to be made by the user, the sphere will blink with a white light in a predetermined frequency (for example 20 Hz). In the present example, the tower thereby is placed in the centre of the map to make it the centre of the player's attention. To select a construction site, each site is highlighted by placing a red square around it. After a construction site has been selected, further options are presented in a circle around the main SSVEP stimulus. As part of the selection process, there should always be an ‘undo’ option, which will undo the result of the previous selection, which is useful for correcting mistakes.

Following game enhancements can be done to make the game more interesting. The player may be allowed for spell casting. Spells cost mana to cast, which is slowly replenished. To cast a spell, the player needs to perform a mental task, like imagined movement or lowering/raising alpha power. Example spells would be a defensive shield, fireballs, temporary structure upgrades, etc. These spells will originate from the main tower. More types of enemies may be invented. Care must be taken that each enemy will have strengths and weaknesses against certain types of structures. More types of structures may be invented. Care must be taken that each structure will have strengths and weaknesses against certain types of enemies. Structures could also split a stream of enemies into strong and weak and send them across different paths.

The EEG recordings in the present example are made with eight electrodes located on the occipital pole (covering the primary visual cortex), namely at positions Oz, O1, O2, POz, PO7, PO3, PO4, PO8, according to the international 10-20 system, as illustrated in FIG. 6. Electrodes T9 and T10 are used as reference and ground, electrodes T9 and T10 being positioned on the left and right mastoids. The raw EEG signal is filtered in the 4-45 Hz frequency band, with a fourth order zero-phase digital Butterworth filter, so as to remove DC and the low frequency drifts, and to remove the 50 Hz powerline interference. The sampling rate was 1000 Hz. Three healthy subjects (all male, aged 26-33 with average age 30, two righthanded, one lefthanded) participated in the experiments.

As a feature, the average response expected for the periodically flashing stimulus were taken. For this, the recorded EEG signal of length t ms was divided into ni=[t/fi] nonoverlapping, consecutive intervals ([.] denotes the integer part of the division), where each interval is linked to the stimulus onset. After that, the average response for all such intervals was computed. Such averaging is necessary because the recorded signal is a superposition of all ongoing brain activities. By averaging the recordings, those that are time-locked to a known event, are extracted as evoked potentials, whereas those that are not related to the stimulus presentation are averaged out. The stronger the evoked potentials, the fewer trials are needed, and vice versa. To illustrate this principle, FIG. 7 shows the result of averaging, for a 2 s recording interval, while the subject was looking at a stimulus flickering at a frequency of 20 Hz. Individual traces of EEG activity and their average (bold line) both are shown, time locked to the stimuli onset. Each individual trace shows EEG signal changes for electrode Oz for subject 1. The length of the shown traces correspond to the duration of the flickering stimulus period (i.e., 3 frames), and for a screen refreshing rate of 59.83 Hz. Note that the average response does not exactly look like integer period of a sinusoid, because the 20 Hz stimulus was constructed using two consecutive frames of intensification followed by frame of no intensification. There is also some latency present in the response since the evoked potential does not appear immediately after the stimuli onset. In order to assess the decoding performance, the EEG recordings were divided into two nonoverlapping subsets (training and testing). This division was made 10 times for every time interval of length t ms, which provides statistics for result comparison. Based on the training set, a classifier was built based on linear discriminant analysis (LDA). This classifier was built for the averaged responses for the time intervals of the stimulus frequencies considered. This classifier was constructed so as to discriminate the stimulus flickering frequency from the case when the subject is not looking at the flickering stimulus at all. As a result of LDA classification (on testing data), a posterior probability was obtained, which characterize the likelihood of a subject's gaze to be directed on the flickering stimulus. If the probability is smaller than 0.5, it was concluded that the subject is not looking at the flickering stimulus.

Since it was not the raw EEG signal that was taken, but rather a 4-45 Hz filtered one, the 1000 Hz sampling frequency is in fact largely redundant. This can lead to zero determinants of the covariance matrices in the LDA estimation. To overcome this, the data was downsampled to a lower resolution (only every fifth sample in the recordings was taken), and only those time instants were taken for which the p-values were smaller than 0.05 in the training data, using a Student t-test between two conditions: averaged response in interval i corresponding to the given stimulus with flickering frequency fᵢ versus the case when the subject not looking at stimulus at all. This feature selection procedure, which is based on a filter approach, enabled to restrict to relevant time instants only.

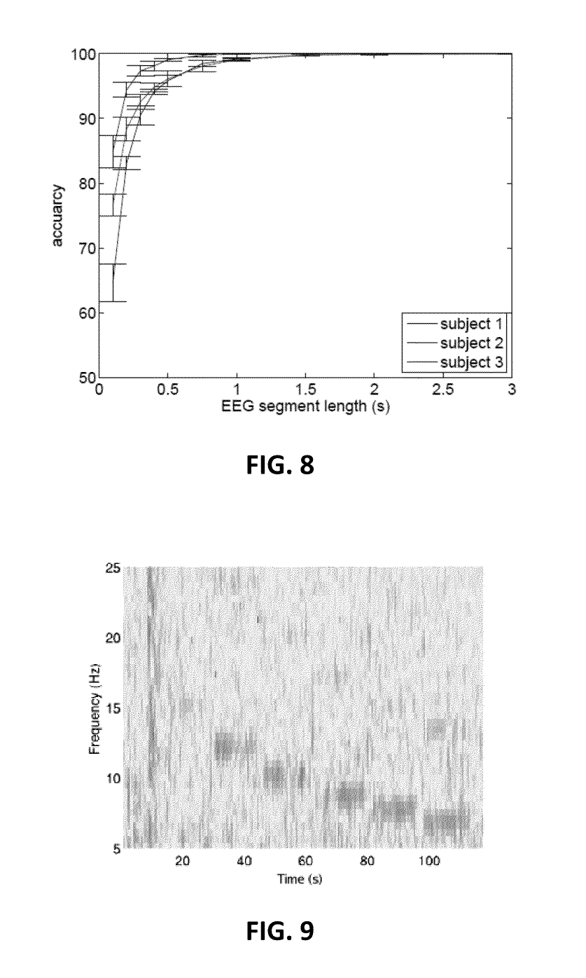

After constructing the classifiers on the training data, they can be applied to test data of all 3 subjects. The obtained results are shown in FIG. 8, plotted as a function of the interval length t. FIG. 8 illustrates the onset/offset detection accuracy (vertical axis) as a function of the length of the EEG interval used for averaging (horizontal axis), plotted for each of the 3 subjects. It can be seen that a 0.5 second interval is sufficient to make an onset/offset decision with high accuracy (>95%) for all 3 subjects. This shows that the proposed SSVEP algorithm is able to achieve a reliable offset detection performance at a fast pace, all in support of the proposed control scheme.

For frequency based decoding techniques, when using too short intervals, neighboring frequencies can not be distinguished because of the limited spectral resolution. For example, 60/9=6.67 Hz and 60/8=7.5 Hz oscillations are indistinguishable after performing a fast FT based on a 500 ms interval (in other words, a spectral resolution of 2 Hz is obtained).

The detection accuracy of one other known time-domain technique introduced in “A user-friendly SSVEP-based brain-computer interface using a time-domain classifier” by Luo and Sullivan in J. Neural Eng. 7, 2010 and of frequency based techniques is indicate by Luo and Sullivan to be determined by a minimum length of interval starting at 2 seconds. Luo and Sullivan state that when the window length is short (M=2 s) and when there is no voting, neither method yields a satisfying performance, although the frequency-domain method performs better, whereby the frequency based techniques provide at this short length is at level of chance (25%). With methods according to the present invention the chance level is at 50% and with a length interval of 0.5 s and a detection accuracy of 95% is obtained. The latter illustrates advantages of embodiments of the present invention.

In a second particular example, an illustration is provided for a method for decoding a steady state visual evoked potential, whereby selecting is made in the amplitude domain for a set of targets each displayed at an own frequency on the same display.

An example of the time domain classifier used in the present example is discussed below, and the detection performance in the present example is evaluated as a function of the recording interval, for 3 subjects. The issue of using several electrodes for decoding is also discussed.

In the present example the EEG recordings were performed using a prototype of an ultra low-power 8-channels wireless EEG system, which consists of two parts: an amplifier coupled with a wireless transmitter and a USB stick receiver. The data is transmitted with a sampling frequency of 1000 Hz for each channel. A brain-cap with large filling holes and sockets for active Ag/AgCI electrodes (ActiCap, Brain Products) was used. The recordings were made with eight electrodes located on the occipital pole (covering the primary visual cortex), namely at positions Oz, O1, O2, POz, PO7, PO3, PO4, PO8, according to the international 10-20 system, see again FIG. 6. The reference electrode and ground were placed on the left and right mastoids. The raw EEG signal is filtered in the 4-45 Hz frequency band, with a fourth order zero-phase digital Butterworth filter, so as to remove DC and the low frequency drifts, and to remove the 50 Hz powerline interference.

Three healthy subjects (all male, aged 26-33 with average age 30, two righthanded, one lefthanded) participated in the experiments. In the beginning of the experiment, a square was shown in the center of the screen, flickering at a frequency of approximately 60/3 Hz, for 15 seconds. After that, during 2 seconds, a blank screen was shown, and then a new square flickering at 60/4 Hz is shown for 15 seconds, and so on. In total, 7 different flickering stimuli were presented to the subject, with frequencies corresponding to the integer divisions of 60 by 3, 4, . . . , 9 (note that these are equal to the lengths of flickering periods in frames). From the recorded EEG signal, the spectrogram was calculated, as illustrated by FIG. 9. The spectrogram shown in FIG. 9 is the spectrogram of EEG recordings from electrode Oz for subject 3, based on a 15 s visual stimulation at frequencies 60/3, . . . , 60/9 Hz, using a 2 s interval between two consecutive stimuli. Note that not only the fundamental frequencies, but also their harmonics are visible. In the experiment, the four most prominent frequencies were later considered for further evaluation for a 4-command SSVEP BCI application. 20, 15, 12 and 10 Hz were chosen for subject 1, 12, 60/7, 7.5, 6.67 Hz were chosen for subject 2 and 10, 60/7, 7.5, 6.67 Hz were chosen for subject 3.

As a feature, the average response expected for each of the flickering stimuli was selected. For this, the recorded EEG signal of length t ms was divided into ni=[t/fi] non-overlapping, consecutive intervals ([.] denotes the integer part of the division), where each interval is linked to the stimulus onset. For example, for 2000 ms recordings, and for a stimulus frequency of 10 Hz, this results in 2000/10=20 such intervals of length 100 ms ([1,100], [101 200], . . . ). This procedure is repeated for all frequencies used in the brain-computer interface set-up, thus, for i=1.4 being the actual four frequencies used for the different subjects. After that, the average response for all such intervals, for each frequency, is computed. Such averaging is advantageous because the recorded signal is a superposition of all ongoing brain activities. By averaging the recordings, those that are time-locked to a known event, are extracted as evoked potentials, whereas those that are not related to the stimulus presentation are averaged out. The stronger the evoked potentials, the fewer data are needed, and vice versa.

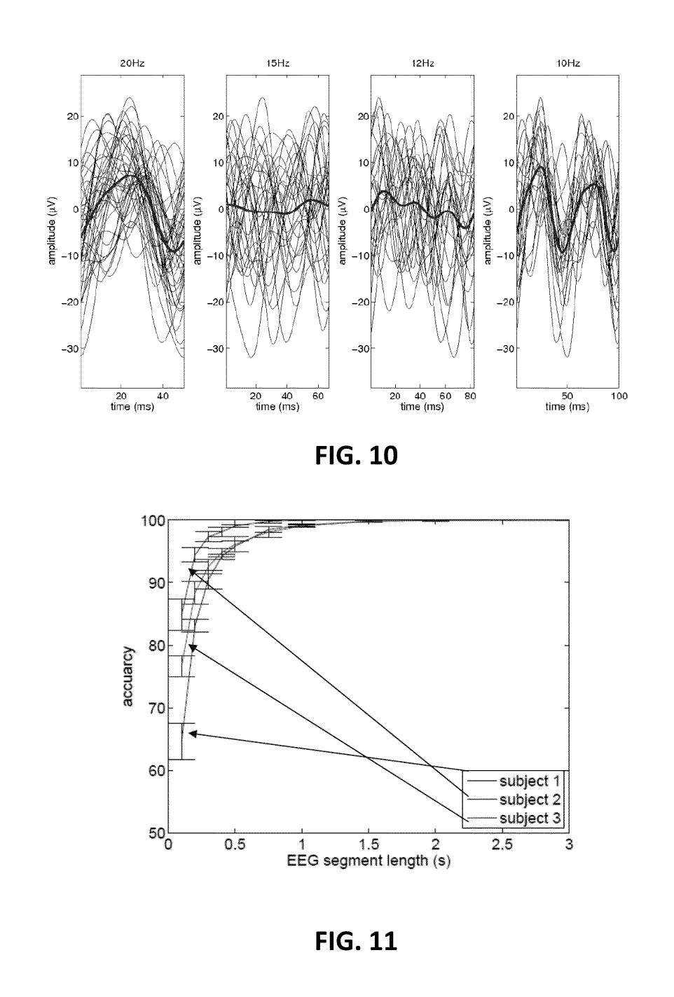

To illustrate this, FIG. 10 shows the result of averaging, for a 2 s recording interval, while the subject was looking at a stimulus flickering at a frequency of 20 Hz. The individual traces of EEG activity as well as the averages are illustrated, time locked to the stimuli onset. Each individual trace shows changes in electrode Oz for subject 1. The lengths of the shown traces correspond to the durations of the flickering periods of 3, 4, 5 and frames (from left to right panel), and with a screen refreshing rate of 59.83 Hz. One observes that, in the left panel, that one complete period for the average trace is obtained, and in the right panel, two complete periods, while in the other panels, the average trace is almost flat. It can be observed that, for the intervals used for detecting the frequencies 12 and 15 Hz, the averaged signals are close to zero, while for those used for 10 and 20 Hz, a clear average response is visible. It is to be noticed that the average response does not exactly look like an integer period of a sinusoid, because the 20 Hz stimulus was constructed using two consecutive frames of intensification followed by frame of no intensification. There is also some latency present in the responses since the evoked potential does not appear immediately after the stimuli onset. It could also be the case that, in the interval used for detecting the 10 Hz oscillation, the average curve consists of two periods. This is as expected, since a 20 Hz oscillation has exactly 2 whole periods in a 100 ms interval. In order to assess the decoding performance, the EEG recordings were divided into two non-overlapping subsets (training and testing).

This division was made 10 times for every time interval of length t ms, which provides us with statistics for result comparison. Based on the training set, 4 classifiers were built based on linear discriminant analysis (LDA). Each of these classifiers was built for the averaged responses for the time intervals of the stimulus frequencies considered (see FIG. 10 where, e.g., 4 of such intervals are shown). These classifiers were constructed so as to discriminate the stimulus flickering frequency fi in window i from

all other flickering frequencies, and for the case when the subject does not look at the flickering stimuli at all. As a result of LDA classification (on testing data), there are four posterior probabilities pi, which characterize the likelihood of a subject's gaze on one of the 4 stimuli flickering at different frequencies fi. If all four probabilities pi are smaller then 0.5, it is concluded that the subject is not looking at the flickering stimuli. In all other cases as an indication of the stimulus the subject's gaze is directed, the flickering frequency fi is taken as response that generates the largest posterior probability pi.

Since the raw EEG signal is not used, but rather a 4-45 Hz filtered one (see above), the 1000 Hz sampling frequency is in fact largely redundant. This can lead to zero determinants of the covariance matrices in the LDA estimation. To overcome this, the data were down sampled to a lower resolution (only every fifth sample in the recordings was used), and took only those time instants, for which the p-values were smaller than 0.05 in the training data, using a Student t-test between two conditions: averaged response in interval i corresponding to the given stimulus with flickering frequency fi versus the case when the subject is looking at an other stimulus, with another flickering frequency, or looking at no stimulus at all. This feature selection procedure, which is based on a filter approach, enables to restrict to relevant time instants only.

The above is valid when using a single electrode. In the case of several electrodes (8 electrodes in our case), the same feature selection was performed for each electrode, but the 4 LDA classifiers were build based on pooled features from all electrodes.

After constructing the classifiers on the training data, they can be applied to test data of all 3 subjects.

Results as shown in FIG. 11 were obtained, plotted as a function of the interval length t. FIG. 11 illustrates the decoding accuracy (vertical axis) as a function of the length of the EEG interval used for averaging (horizontal axis). It can be seen that a 1 second interval is sufficient to make a decision with high accuracy for all subjects, and for a brain computer interface application with four different frequencies (+also distinguishing the case where the subject is not looking at any stimuli). This shows that the proposed time domain BCI is able to achieve a reliable offset detection performance at a fast pace, all in support of the proposed control scheme and thus is able to achieve a performance with a high information transfer rate. The dependency of the decoding accuracy on the number of electrodes used for decoding was also verified. As was expected, the highest accuracy was obtained for electrodes placed along the central line (Oz or POz). Taking all eight electrodes together generates a significantly better performance than the case of only a single electrode. Finally, for EEG recordings with an interval length above 1.5 sec, there is no difference in decoding performance. The use of bristle dry electrodes (Med-Cat) was also tested instead of active wet ones (ActiCap, Brain Products). Dry electrodes enable the preparation time of the subject to be reduced to the absolute minimum, of dead skin cells: the EEG cap is put on and one is ready for recording, all in a few seconds. But on the other hand, they have a large impedance, which leads to weak signals and inferior decoding results. Given the positions O1 and Ofor the dry electrodes, the decoding accuracy as a function of the EEG recoding length was estimated, and compared with the accuracy obtained with the active electrodes, for the same electrode locations. It was found that, to achieve the same accuracy as with the active wet electrodes, at least a 4 times longer EEG intervals was to be considered, although also advantages are coupled to the use of dry electrodes.

For frequency based decoding techniques, when using too short intervals, neighboring frequencies cannot be distinguished because of the limited spectral resolution. For example 60/9=6.67 Hz and 60/8=7.5 Hz oscillations are indistinguishable after performing a fast FT based on a 500 ms interval (in other words, there is a spectral resolution of 2 Hz).

In the prior art technique using time-domain evaluation discussed by Luo and Sullivan, in J. Neural Eng. 7 (2010) the detection accuracy for their time domain based technique and for frequency based techniques indicate a minimum length of interval of 2 seconds and the detection accuracy of the frequency based techniques is at level of chance (25%). In the present example the chance level is 50% and with a length interval of 0.5 s we get a detection accuracy of 95%.

1-25. (canceled)

26. A computerized method for decoding visual evoked potentials, the method comprising
obtaining a set of brain activity signals, the brain activity signals being recorded from a subject's brain during displaying a set of targets on a display having a display frame duration, at least one target being modulated periodically using a target-specific modulation parameter,
decoding a visual evoked potential (VEP) from the brain activity signals, wherein said decoding comprises
at least for the at least one target being modulated at a target-specific modulation parameter, determining a representative time track from the obtained brain activity signals, the representative time track having a length being integer multiples of the display frame duration,
analyzing at least one amplitude feature in the representative time track, and
determining a most likely target of interest or absence thereof based on said analyzing.

27. The computerized method for decoding according to claim 26, wherein determining a representative time track in the obtained brain activity signals for a target-specific modulation parameter comprises deriving from the obtained brain activity signals a set comprising one or more subsequent time tracks, locked to the stimulus phase, and averaging the set of time tracks for obtaining the representative time track for the target-specific frequency modulation parameter.

28. The computerized method according to claim 26, wherein a modulation parameter is any of a target-specific frequency, a target-specific set of frequencies, a target specific phase, or a combination thereof.

29. The computerized method according to claim 26, wherein the visual evoked potential is a steady state evoked potential.

30. The computerized method for decoding according to claim 26, wherein determining a representative time track comprises determining a representative time track having a length being substantially smaller than a time length required by a frequency analysis of the signal in order for the target to be distinguishable, with a comparable precision, from one or more other targets.

31. The computerized method for decoding according to claim 26, wherein the brain activity signals are captured using two or more electrodes.

32. The computerized method according to claim 31, wherein the brain activity signals are electro encephalogram (EEG) signals.

33. The computerized method according to claim 26, the set of targets comprising a target being a VEP stimulus for the subject to keep gaze at and the set of targets furthermore comprising sequentially displayed targets presenting options displayed in the periphery of the VEP stimulus at different presentation moments in time, wherein
determining a representative time track comprises frequently updating a representative time track of the target the subject currently gazes at during the period of said sequentially displaying targets presenting options and wherein—analyzing one or more amplitude features in the representative time track comprises detecting a moment at which a change in one or more amplitude features of the representative time track occurs, and
wherein for determining a most likely target of interest, the method comprises linking the moment at which a change in one or more amplitude features of the representative time track occur to the presentation moment for a target presenting an option and identifying that target as most likely target of interest.

34. The computerized method according to claim 33, wherein said determining a most likely target of interest is based on covert attention of the subject.

35. The computerized method according to claim 33, wherein detecting a moment at which a change in one or more amplitude features occurs comprises analyzing if the value of one or more amplitude features crosses a predetermined threshold.

36. The computerized method for decoding according to claim 26, wherein each of the targets of the set of targets is displayed modulated at a target-specific modulation parameter, and whereby decoding a visual evoked potential from the brain activity signals comprises,
for one or more target-specific modulation parameter determining a representative time track,
selecting a most likely representative time track or absence thereof based on one or more amplitude features in the representative time track for the one or more target-specific modulation parameter, and
determining the most likely target of interest or absence thereof based on the most likely representative track or absence thereof.

37. The computerized method according to claim 36, wherein determining a representative time track is performed for each target in the set of targets.

38. The computerized method according to claim 36, wherein selecting a most likely representative time track or absence thereof is based on evaluating amplitude features in the representative time track for the one or more target-specific modulation parameter according to predetermined criteria.

39. The computerized method according claim 26, wherein the obtained brain activity signals are recorded on the occipital pole.

40. A system for decoding visual evoked potentials, the system comprising
an input arranged to obtain a set of brain activity signals, the brain activity signals being recorded from the subject's brain during displaying of a set of targets, at least one target being modulated at a target-specific modulation parameter,
a processor configured to decode a visual evoked potential (VEP) from the brain activity signals, the processor comprising
a representative time track determining arrangement configured to determine, at least for the at least one target being modulated at a target-specific modulation parameter, a representative time track from the obtained brain activity signals, the representative time track having a length being integer multiples of frame duration
an analyzer arranged to analyze at least one amplitude feature in the representative time track, and
a target determination arrangement configured to determine a most likely target of interest or absence thereof based on said analyzing.

41. The system according to claim 40, comprising a display arranged to display a set of targets, at least one target of said set being modulated at a target-specific modulation parameter.

42. The system according to claim 40, wherein the system comprises a controller programmed to control decoding of a visually evoked potential.

43. A computer program product for performing, when executed on a computer, a method for decoding visual evoked potentials, the method comprising
obtaining a set of brain activity signals, the brain activity signals being recorded from a subject's brain during displaying a set of targets on a display having a display frame duration, at least one target being modulated periodically using a target-specific modulation parameter,
decoding a visual evoked potential (VEP) from the brain activity signals, wherein said decoding comprises
at least for the at least one target being modulated at a target-specific modulation parameter, determining a representative time track from the obtained brain activity signals, the representative time track having a length being integer multiples of the display frame duration,
analyzing at least one amplitude feature in the representative time track, and
determining a most likely target of interest or absence thereof based on said analyzing.

44. The computer program product according to claim 43, stored on a machine readable data storage device.

45. The computer program product according to claim 43, the computer program product being transmitted over a local or wide area telecommunications network.
